(19) United States
(12) Patent Application Publication
(10) Pub. No.: US 2011/0241988 A1
(43) Pub. Date: Oct. 6, 2011

(54) INTERACTIVE INPUT SYSTEM AND INFORMATION INPUT METHOD THEREFOR

(75) Inventor: Tim Bensler, Calgary (CA)

(73) Assignee: SMART Technologies ULC, Calgary (CA)

(21) Appl. No.: 12/753,077

(22) Filed: Apr. 1, 2010

(51) Int. Cl. G09G 5/08; G06F 3/033

(52) U.S. Cl. 345/158; 345/179

(57) ABSTRACT

An interactive input system includes at least one imaging device having a field of view looking into a region of interest and capturing images; at least one pen tool comprising an accelerometer configured to measure acceleration of the pen tool and to generate acceleration data, the pen tool configured to wirelessly transmit the acceleration data; and processing structure configured to process the images and acceleration data to determine the location of at least one pointer in the region of interest.

### FIELD OF THE INVENTION

The present invention relates to an interactive input system and to an information input method therefor.

### BACKGROUND OF THE INVENTION

Interactive input systems that allow users to inject input (e.g., digital ink, mouse events etc.) into an application program using an active pointer (e.g., a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

U.S. Pat. No. 6,803,906 to Morrison, et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x, y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison, et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

Typical camera-based interactive input systems determine pointer position proximate a region of interest using triangulation based on image data captured by two or more imaging assemblies, each of which has a different view of the region of prediction. When a single pointer is within the field of view of the imaging assemblies, determination of pointer position is straightforward. However, when multiple pointers are within the field of view, ambiguities in pointers' positions can arise when the multiple pointers cannot be differentiated from each other in the captured image data. For example, one pointer may be positioned so as to occlude another pointer from the viewpoint of one of the imaging assemblies. FIG. 1 shows an example of such an occlusion event that occurs when two moving pointers cross a line of sight of an imaging assembly. Here, pointer 1, moving down and to the right, will at one point occlude pointer 2, moving up and to the left, in the line of sight of imaging assembly 1. As will be appreciated, it can be non-trivial for the interactive input system to correctly identify the pointers after the occlusion. In particular, the system encounters challenges differentiating between the scenario of pointer 1 and pointer 2 each moving along their original respective trajectory after the occlusion, and the scenario of pointer 1 and pointer 2 reversing course during the occlusion and each moving opposite to their original respective trajectory.

Several approaches to improving detection in camera-based interactive input systems have been developed. For example, United States Patent Application Publication No. US2008/0143690 to Jang, et al. discloses a display device having a multi-touch recognition function that includes an integration module having a plurality of cameras integrated at an edge of a display panel. The device also includes a look-up-table of a plurality of compensation angles in an range of about 0 to about 90 degrees corresponding to each of the plurality of cameras, and a processor that detects a touch area using at least first and second images captured by the plurality of cameras, respectively. The detected touch area are compensated with one of the plurality of compensation angles.

United States Patent Application Publication No. US2007/0116333 to Dempski, et al. discloses a system and method for determining positions of multiple targets on a planar surface. The targets subject to detection may include a touch from a body part (such as a finger), a pen, or other objects. The system and method may use light sensors, such as cameras, to generate information for the multiple simultaneous targets (such as finger, pens, etc.) that are proximate to or on the planar surface. The information from the cameras may be used to generate possible targets. The possible targets include both “real” targets (a target associated with an actual touch) and “ghost” targets (a target not associated with an actual touch). Using analysis, such as a history of previous targets, the list of potential targets may then be narrowed to the multiple targets by analyzing state information for targets from a previous cycle (such as the targets determined during a previous frame).

PCT Application No. PCT/CA2010/000190 to McGibney, et al. entitled “Active Display Feedback in Interactive Input Systems” filed on Feb. 11, 2010, assigned to SMART Technologies, ULC of Calgary, Alberta, Canada, assignee of the subject application, the contents of which are incorporated herein, discloses a method for distinguishing between a plurality of pointers in an interactive input system and an interactive input system employing the method. A visual indicator, such as a gradient or a colored pattern is flashed along the estimated touch point positions. Ambiguities are removed by detecting the indicator and real pointer locations are determined.

U.S. application Ser. No. 12/501,088 to Chtchetinine, et al. entitled “Interactive Input System” filed on Jul. 10, 2009, assigned to SMART Technologies, ULC of Calgary, Alberta, Canada, assignee of the subject application, the contents of which are incorporated herein, discloses a multi-touch interactive input system. The interactive input system includes an input surface having at least two input areas. A plurality of imaging devices mounted on the periphery of the input surface have at least partially overlapping fields of view encompassing at least one input region within the input area. A processing structure processes image data acquired by the imaging devices to track the position of at least two pointers, assigns a weight to each image, and resolve ambiguities between the pointers based on each weighted image.

PCT Application No. PCT/CA2009/000773 to Zhou, et al. entitled “Interactive Input System and Method” filed on Jun. 5, 2009, assigned to SMART Technologies, ULC of Calgary, Alberta, Canada, assignee of the subject application, the contents of which are incorporated herein, discloses a multi-touch interactive input system and a method that is able to resolve pointer ambiguity and occlusion. A master controller in the system comprises a plurality of modules, namely a birth module, a target tracking module, a state estimation module and a blind tracking module. Multiple targets present on the touch surface of the interactive input system are detected by these modules from birth to final determination of the positions, and used to resolve ambiguities and occlusions.

Although many different types of interactive input systems exist, improvements to such interactive input systems are continually being sought. It is therefore an object of the present invention to provide a novel interactive input system and an information input method therefor.

### SUMMARY OF THE INVENTION

Accordingly, in one aspect there is provided an interactive input system comprising:
at least one imaging device having a field of view looking into a region of interest and capturing images;
at least one pen tool comprising an accelerometer configured to measure acceleration of the pen tool and to generate acceleration data, the pen tool configured to wirelessly transmit the acceleration data; and
processing structure configured to process the images and acceleration data to determine the location of at least one pointer in the region of interest.

According to another aspect there is provided a pen tool for use with an interactive input system, the interactive input system comprising at least one imaging assembly capturing images of a region of interest, the interactive input system further comprising processing structure configured for locating a position of the pen tool when positioned in the region of interest, the pen tool comprising:
an accelerometer configured for measuring acceleration of the pen tool and generating acceleration data; and
a wireless unit configured for wirelessly transmitting the acceleration data.

According to yet another aspect there is provided a method of inputting information into an interactive input system comprising at least one imaging assembly capturing images of a region of interest, the method comprising:
determining the position of at least two pointers in the region of interest, at least one of the at least two pointers being a pen tool comprising an accelerometer and transmitting accelerometer data to the system, the determining comprising processing image data captured by the at least one imaging assembly and accelerometer data received by the system.

The methods, devices and systems described herein provide at least the benefit of reduced pointer location ambiguity to improve the usability of the interactive input systems to which they are applied.

### BRIEF DESCRIPTION OF THE DRAWINGS

Embodiments will now be described more fully with reference to the accompanying drawings in which:

FIG. 1 is a view of a region of interest of an interactive input system of the prior art.

FIG. 2 is a schematic diagram of an interactive input system.

FIG. 3 is a block diagram of an imaging assembly.

FIG. 4 is a block diagram of a master controller.

FIG. 5 is an exploded side elevation view of a pen tool incorporating an accelerometer.

FIG. 6 is a block diagram representing the components of the pen tool of FIG. 5.

FIG. 7 is a flowchart showing a data output process for the pen tool of FIG. 5.

FIG. 8 is a flowchart showing a pointer identification process.

FIGS. 9a and 9b are flowcharts showing a pointer tracking process.

FIG. 10 is a schematic view showing orientation of a pen tool coordinate system with respect to that of a touch surface.

FIG. 11 is a schematic view showing parameters for calculating a correction factor used by the interactive input system of FIG. 2.

FIG. 12 is a schematic view of an exemplary process for updating a region of prediction used in the process FIGS. 9a and 9b.

FIG. 13 is a schematic view of actual and calculated positions of two occluding pen tools determined using the process of FIGS. 9a and 9b, for which each pointer maintains its respective trajectory after occlusion.

FIG. 14 is a schematic view showing other possible positions of the pen tools of FIG. 13, determined using the process of FIGS. 9a and 9b.

FIG. 15 is a schematic view of actual and calculated positions of two occluding pen tools determined using the process of FIGS. 9a and 9b, for which each pointer reverses its respective trajectory after occlusion.

FIG. 16 is a side view of another embodiment of an interactive input system.

### DETAILED DESCRIPTION OF THE EMBODIMENTS

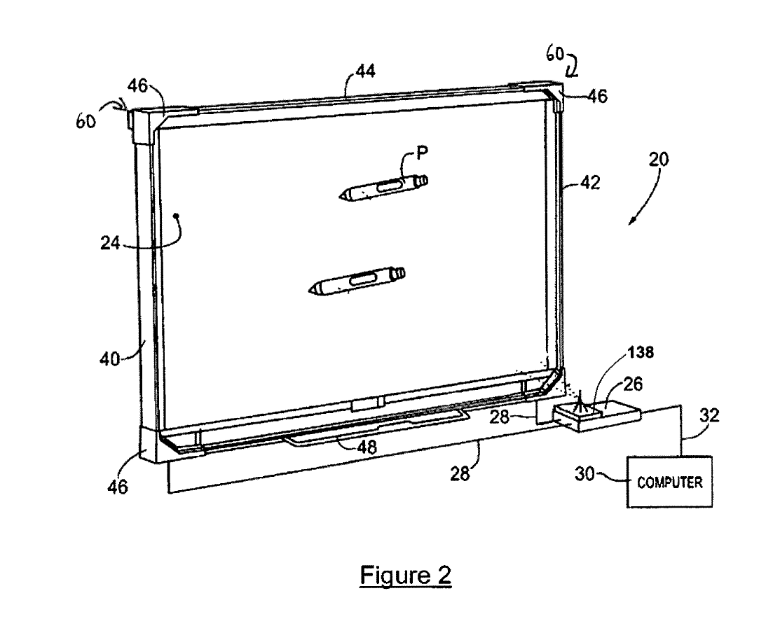

Turning now to FIG. 2, an interactive input system that allows a user to inject input such as digital ink, mouse events etc. into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into a region of prediction in proximity with the display surface 24 and communicates with a digital signal processor (DSP) unit 26 via communication lines 28. The communication lines 28 may be embodied in a serial bus, a parallel bus, a universal serial bus (USB), an Ethernet connection or other suitable wired connection. Alternatively, the imaging assembly 22 may communicate with the DSP unit 26 over a wireless connection using a suitable wireless protocol such as for example Bluetooth, WiFi, ZigBee, ANT, IEEE 802.15.4, Z-Wave etc. The DSP unit 26 in turn communicates via a USB cable 32 with a processing structure, in this embodiment computer 30, executing one or more application programs. Alternatively, the DSP unit 26 may communicate with the computer 30 over another wired connection such as for example, a parallel bus, an RS-232 connection, an Ethernet connection etc. or may communicate with the computer 30 over a wireless connection using a suitable wireless protocol such as for example Bluetooth, WiFi, ZigBee, ANT, IEEE 802.15.4, Z-Wave etc. Computer 30 processes the output of the assembly 22 received via the DSP unit 26 and adjusts image data that is output to the display unit so that the image presented on the display surface 24 reflects pointer activity. In this manner, the assembly 22, DSP unit 26 and computer 30 allow pointer activity proximate to the display surface 24 to be recorded as writing or drawing or used to control execution of one or more application programs executed by the computer 30.

Assembly 22 comprises a frame assembly that is mechanically attached to the display unit and surrounds the display surface 24. Frame assembly comprises a bezel having three bezel segments 40, 42 and 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more pen tools. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60 that look generally across the entire display surface 24 from different vantages. The bezel segments 40, 42 and 44 are oriented so that their inwardly facing surfaces are seen by the imaging assemblies 60.

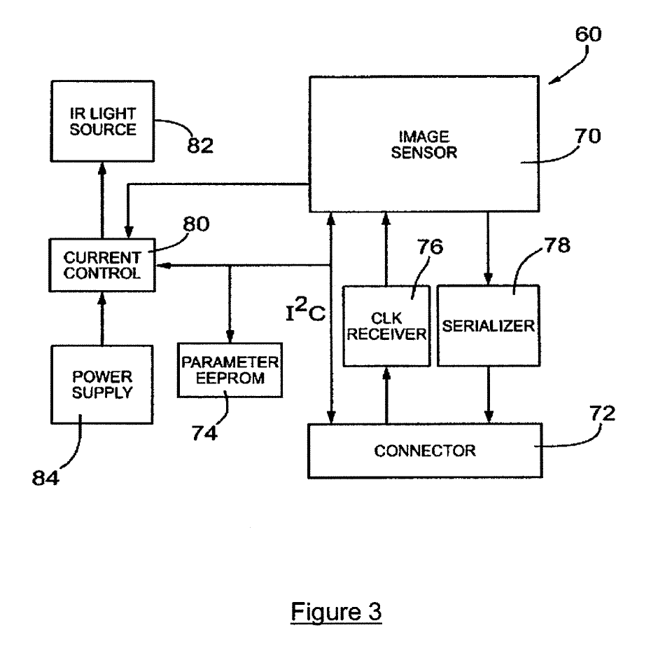

Turning now to FIG. 3, one of the imaging assemblies 60 is better illustrated. As can be seen, the imaging assembly 60 comprises an image sensor 70 such as that manufactured by Micron under model No. MT9V022, fitted with an 880 nm lens of the type manufactured by Boowon under model No. BW25B. The lens has an IR-pass/visible light blocking filter thereon (not shown) and provides the image sensor 70 with approximately a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is also connected to an infrared (IR) light source 82 comprising at least one IR light emitting diode (LED) and associated lens assemblies as well as to a power supply 84 and the connector 72.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determines the rate at which the image sensor 70 captures and outputs image frames. Each image frame output by the image sensor 70 is serialized by the serializer 78 and output to the DSP unit 26 via the connector 72 and communication lines 28.

In this embodiment, the inwardly facing surface of each bezel segment 40, 42 and 44 comprises a single generally horizontal strip or band of retro-reflective material. To take best advantage of the properties of the retro-reflective material, the bezel segments 40, 42 and 44 are oriented so that their inwardly facing surfaces extend in a plane generally normal to that of the display surface 24.

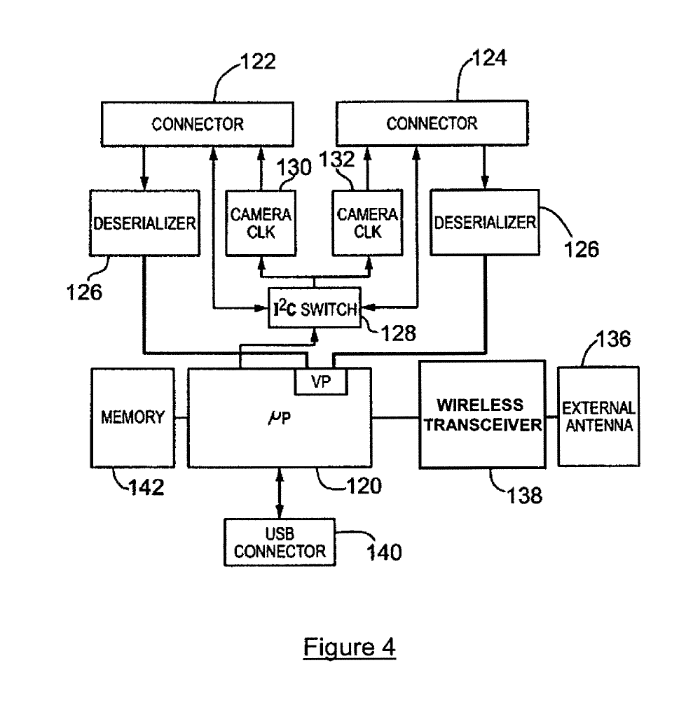

Turning now to FIG. 4, the DSP unit 26 is better illustrated. As can be seen, DSP unit 26 comprises a controller 120 such as for example, a microprocessor, microcontroller, DSP, other suitable processing structure etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, and each clock is connected to a respective one of the connectors 122, 124. The controller 120 communicates with a USB connector 140 that receives USB cable 32 and memory 142 including volatile and non-volatile memory. The clocks 130 and 132 and deserializers 126 similarly employ low voltage, differential signaling (LVDS).

The interactive input system 20 is able to detect passive pointers such as for example, a user's finger, a cylinder or other suitable object as well as active pen tools that are brought into proximity with the display surface 24 and within the fields of view of the imaging assemblies 60.

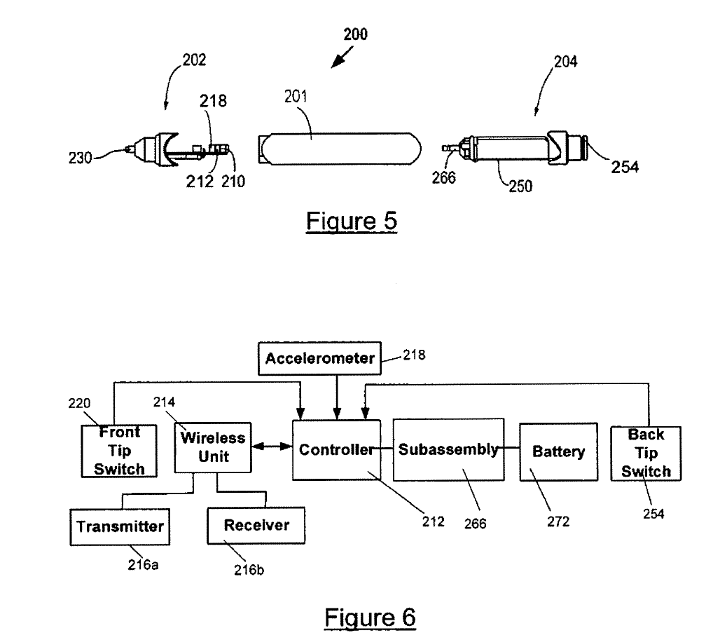

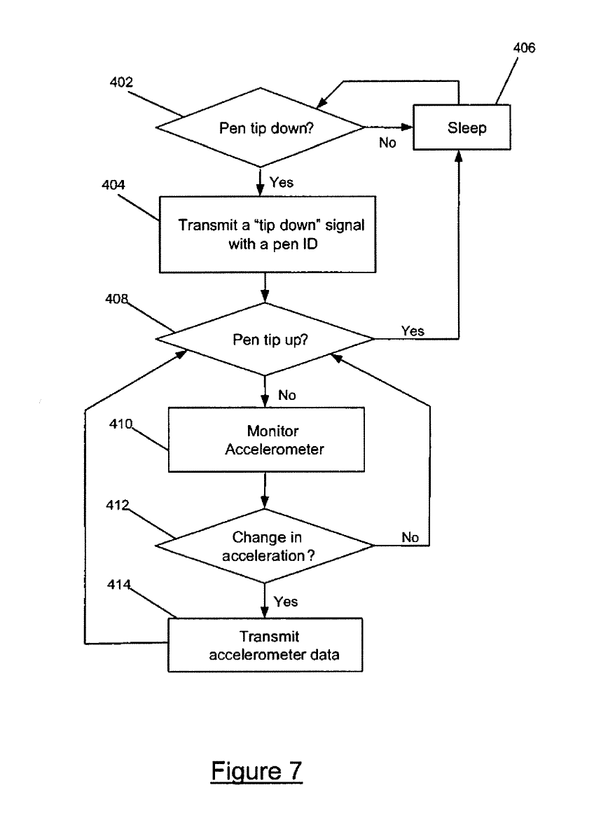

FIGS. 5 and 6 show a pen tool for use with interactive input system 20, generally indicated using reference numeral 200. Pen tool 200 comprises a longitudinal hollow shaft 201 having a first end to which a tip assembly 202 is mounted. Tip assembly 202 includes a front tip switch 220 that is triggered by application of pressure thereto. Tip assembly 202 encloses a circuit board 210 on which a controller 212 is mounted. Controller 212 is in communication with front tip switch 220, and also with an accelerometer 218 mounted on circuit board 210. Controller 212 is also in communication with a wireless unit 214 configured for transmitting signals via wireless transmitter 216a, and for receiving wireless signals via receiver 216b. In this embodiment, the signals are radio frequency (RF) signals.

Longitudinal shaft 201 of pen tool 200 has a second end to which an eraser assembly 204 is mounted. Eraser assembly 204 comprises a battery housing 250 having contacts for connecting to a battery 272 accommodated within the housing 250. Eraser assembly 204 also includes a rear tip switch 254 secured to an end of battery housing 250, and which is in communication with controller 212. Rear tip switch 254 may be triggered by application of pressure thereto, which enables the pen tool 200 to be used in an “eraser mode”. Further details of the rear tip switch 254 and the “eraser mode” are provided in U.S. Patent Application Publication No. 2009/0277697 to Bolt, et al., assigned to the assignee of the subject application, the content of which is incorporated herein by reference in its entirety. An electrical subassembly 266 provides electrical connection between rear circuit board 252 and circuit board 210 of tip assembly 204 such that rear tip switch 254 is in communication with controller 212, as illustrated in FIG. 6.

Many kinds of accelerometer are commercially available, and are generally categorized into 1-axis, 2-axis, and 3-axis formats. 3-axis accelerometers, for example, are capable of measuring acceleration in three dimensions (x, y, z), and are therefore capable of generating accelerometer data having components in these three dimensions. Some examples of 2- and 3-axis accelerometers include, but are in no way limited to, MMA7331LR1 manufactured by Freescale, ADXL323KCPZ-RL manufactured by Analog Devices, and LIS202DLTR manufactured by STMicroelectronics. As touch surface 24 is two-dimensional, in this embodiment, only two dimensional accelerometer data is required for locating the position of pen tool 200. Accordingly, in this embodiment, accelerometer 218 is a 2-axis accelerometer.

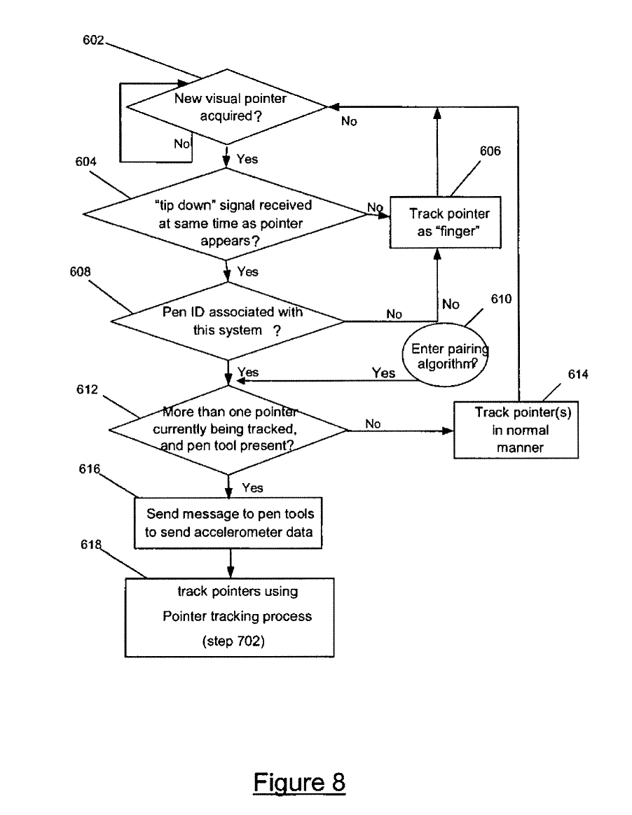

FIG. 7 shows the steps of a data output process used by pen tool 200. When front tip switch 220 is depressed, such as when pen tool 200 is brought into contact with touch surface 24 during use (step 402), controller 212 generates a “tip down” status and communicates this status to wireless unit 214. Wireless unit 214 in turn outputs a “tip down” signal including an identification of the pen tool (“pen ID”) that is transmitted via the wireless transmitter 216a (step 404). This signal, upon receipt by the wireless transceiver 138 in DSP unit 26 of interactive input system 20, is then communicated to the main processor in DSP unit 26. Controller 212 continuously monitors front tip switch 220 for status. When front tip switch 220 is not depressed, such as when pen tool 200 is removed from contact with touch surface 24, controller 212 generates a “tip up” signal. The generation of a “tip up” signal causes pen tool 200 to enter into a sleep mode (step 406). Otherwise, if no “tip up” signal is generated by controller 212, accelerometer 218 measures the acceleration of pen tool 200, and communicates accelerometer data to the controller 212 for monitoring (step 410). Here, a threshold for the accelerometer data may be optionally defined within the controller 212, so as to enable controller 212 to determine when only a significant change in acceleration of pen tool 200 occurs (step 412). If the accelerometer data is above the threshold, wireless unit 214 and transmitter 216a transmit the accelerometer data to the DSP unit 26 (step 414). The process then returns to step 408, in which controller 212 continues to monitor for a “tip up” status.

As will be appreciated, ambiguities can arise when determining the positions of multiple pointers from image data captured by the imaging assemblies 60 alone. Such ambiguities can be caused by occlusion of one pointer by another, for example, within the field of view of one of the imaging assemblies 60. However, if one or more of the pointers is a pen tool 200, these ambiguities may be resolved by combining image data captured by the imaging assemblies with accelerometer data transmitted by the pen tool 200.

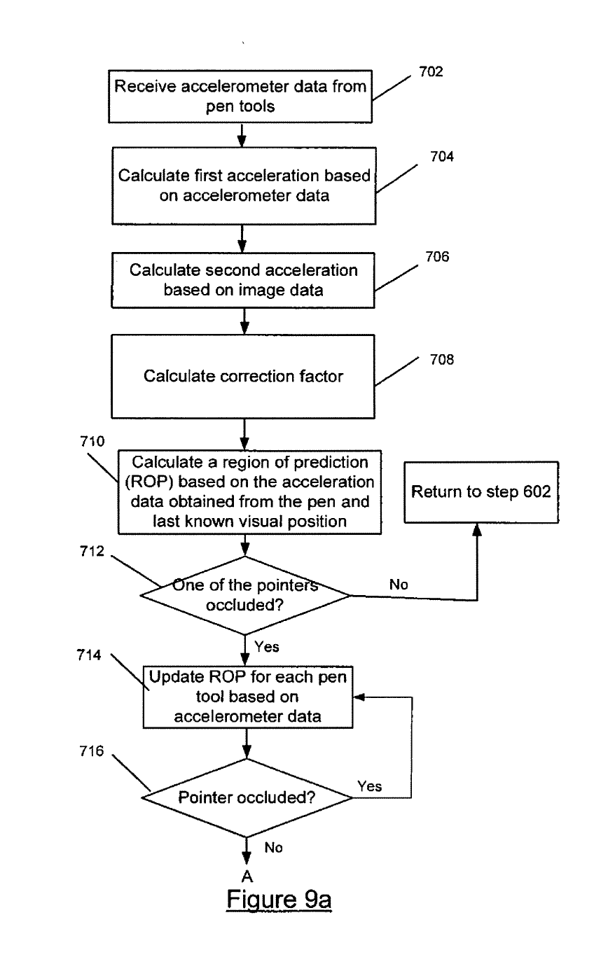

FIG. 8 illustrates a pointer identification process used by the interactive input system 20. When a pointer is first brought into proximity with the input surface 24, images of the pointer are captured by imaging assemblies 60 and are sent to DSP unit 26. The DSP unit 26 then processes the image data and recognizes that a new pointer has appeared (step 602). Here, DSP unit 26 maintains and continuously checks an updated table of all pointers being tracked, and any pointer that does not match a pointer in this table is recognized as a new pointer. Upon recognizing the new pointer, DSP unit 26 then determines whether any “tip down” signal has been received by wireless transceiver 138 (step 604). If no such signal has been received, DSP unit 26 determines that the pointer is a passive pointer, referred to here as a “finger” (step 606), at which point the process returns to step 602. If a “tip down” signal has been received, DSP unit 26 determines that that the pointer is a pen tool 200. DSP unit 26 then checks its pairing registry to determine if the pen ID, received by wireless transceiver 138 together with the “tip down” signal, is associated with the interactive input system (step 608). Here, each interactive input system 20 maintains an updated registry listing pen tools 200 that are paired with the interactive input system 20, together with their respective pen ID's. If the received pen ID is not associated with the system, a prompt to run an optional pairing algorithm is presented (step 610). Selecting “yes” at step 610 runs the pairing algorithm, which causes the DSP unit 26 to add this pen ID to its pairing registry. If “no” is selected at step 610, the process returns to step 606 and the pointer is subsequently treated as a “finger”. The DSP unit 26 then checks its updated table of pointers being tracked to determine if more than one pointer is currently being tracked (step 612).

If there is only one pointer currently being tracked, the system locates the position of the pointer by triangulation based on captured image data only (step 614). Details of triangulation based on captured image data are described in PCT Application No. PCT/CA2009/000773 to Zhou, et al., entitled “Interactive Input System and Method” filed on Jun. 5, 2009, assigned to SMART Technologies, ULC of Calgary, Alberta, Canada, assignee of the subject application, the content of which is incorporated herein by reference in its entirety. At this stage, it is not necessary for the DSP unit 26 to acquire accelerometer data from the pen tool 200 for locating its position. Thus, the pen tool 200 is not required at this point to transmit accelerometer data, thereby preserving battery pen tool battery life.

If more than one pointer is currently being tracked, but none of the pointers are pen tools, the system also locates the positions of the pointers using triangulation based on captured image data only.

If more than one pointer is currently being tracked, and at least one of the pointers is a pen tool 200, then the DSP unit 26 transmits a signal to all pen tools currently being tracked by the interactive input system 20 requesting accelerometer data (step 616). DSP unit 26 will subsequently monitor accelerometer data transmitted by the pen tools 200 and received by wireless transceiver 138, and will use this accelerometer data in the pen tool tracking process (step 618), as will be described.

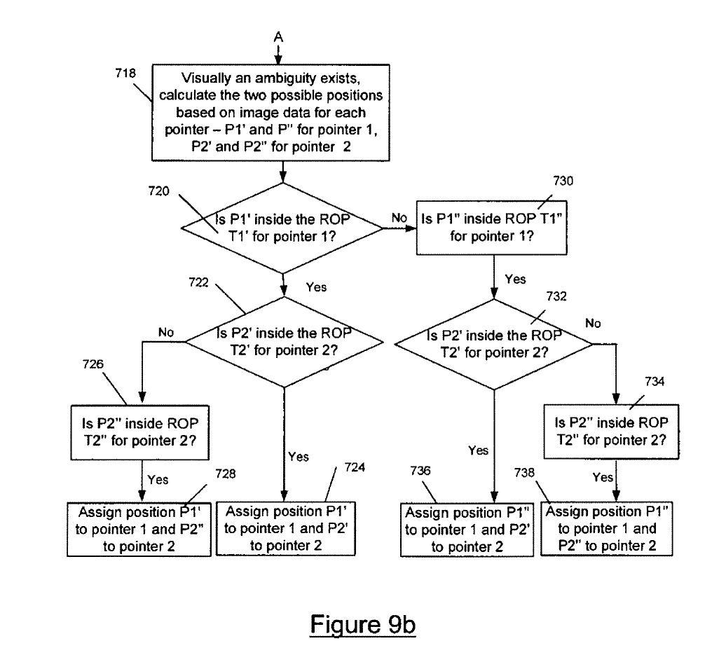

FIGS. 9a and 9b illustrate a pen tool tracking process used by the interactive input system 20, in which image data is combined with accelerometer data to determine pointer positions. First, DSP unit 26 receives accelerometer data from each pen tool (step 702). DSP unit 26 then calculates a first acceleration of each pen tool 200 based on the received accelerometer data alone (step 704). DSP unit 26 then calculates a second acceleration of each pen tool 200 based on captured image data alone (step 706). In this embodiment, the calculated first and second accelerations are vectors each having both a magnitude and a direction. For each pen tool 200, DSP unit 26 then proceeds to calculate a correction factor based on the first and second accelerations (step 708).

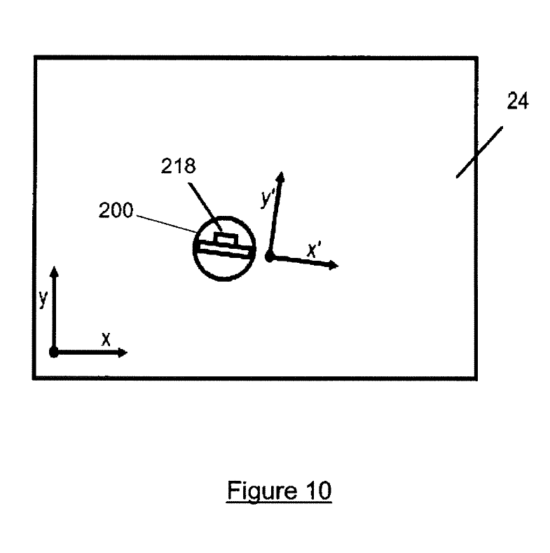

As will be appreciated, when pen tool 200 is picked up by a user during use, it may have been rotated about its longitudinal axis into any arbitrary starting orientation. Consequently, the coordinate system (x′, y′) of the accelerometer 218 within pen tool 200 will not necessarily be aligned with the fixed coordinate system (x, y) of the touch surface 24. The relative orientations of the two coordinate systems are schematically illustrated in FIG. 10. The difference in orientation may be represented by an offset angle between the two coordinate systems. This offset angle is taken into consideration when correlating accelerometer data received from pen tool 200 with image data captured by the imaging assemblies 60. This correlation is accomplished using a correction factor.

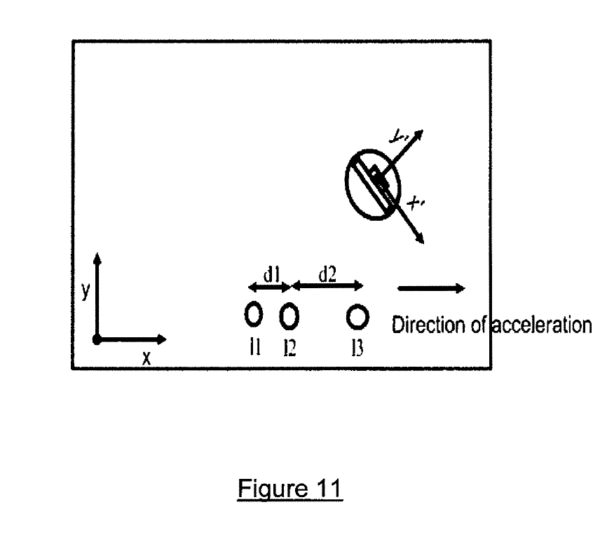

FIG. 11 schematically illustrates a process used for determining the correction factor for a single pen tool. In this example, the coordinate system (x′, y′) of the accelerometer 218 is oriented at an angle of 45 degrees relative to the coordinate system (x, y) of the touch surface 24. Three consecutive image frames captured by the two imaging assemblies are used to determine the correction factor. The DSP unit 26, using triangulation based on image data, determines the positions of the pen tool in each of the three captured image frames, namely positions l1, l2 and l3. Based on these three observed positions, DSP unit 26 determines that the pen tool is accelerating purely in the x direction. However, DSP unit 26 is also aware that the pen tool is transmitting accelerometer data showing an acceleration along a direction having vector components in both the x′ and y′ directions. Using this information, the DSP unit 26 then calculates the offset angle between the coordinate system (x′, y′) of the accelerometer 218 and the coordinate system (x, y) of the touch surface 24, and thereby determines the correction factor.

Once the correction factor has been determined, it is applied to the accelerometer data subsequently received from the pen tool 200. DSP unit 26 then calculates a region of prediction (ROP) for each of the pointers based on both the accelerometer data and the last known position of pen tool 200. The last known position of pen tool 200 is determined using triangulation as described above, based on captured image data (step 710). The ROP represents an area into which each pointer may possibly have traveled. The DSP unit 26 then determines whether any of the pointers are occluded by comparing the number of pointers seen by each of the imaging assemblies (step 712). In this embodiment, any difference in the number of pointers seen indicates an occlusion has occurred. If no occlusion has occurred, the process returns to step 602 and continues to check for the appearance of new pointers. If an occlusion has occurred, the DSP unit 26 updates the calculated ROP for pen tool 200 based on the accelerometer data received (step 714). Following this update, the DSP unit 26 determines whether any of the pointers are still occluded (step 716). If so, the process returns to step 714 and DSP unit 26 continues to update the ROP for each pointer based on the accelerometer data that is continuously being received.

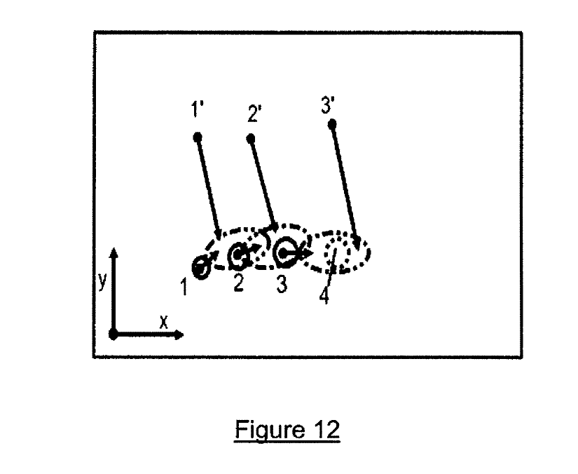

FIG. 12 schematically illustrates an exemplary process used in step 714 for updating the calculated ROP. The last known visual position 1 of a pen tool and accelerometer data from the pen tool, are both used for calculation of an ROP 1′. An updated ROP 2′ can then be determined using both image data showing the pen tool at position 2, and accelerometer data transmitted from the pen tool at position 2. At position 3, a change in direction of the pen tool causes transmission of accelerometer data that has an increased acceleration component along the x axis but a decreased acceleration component along the y axis, as compared with the accelerometer data transmitted from position 2. An ROP 3′ is calculated using the image data obtained from position 3 and the new accelerometer data. Accordingly, a predicted position 4 of the pen tool will lie immediately to the right of location 3 and within ROP 3′, which is generally oriented in the x direction.

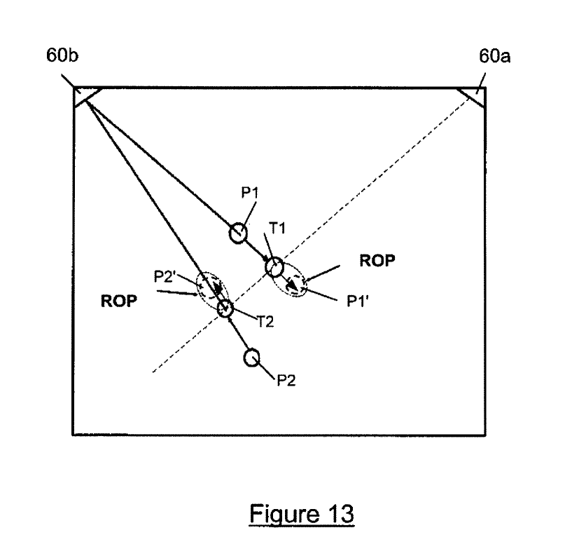

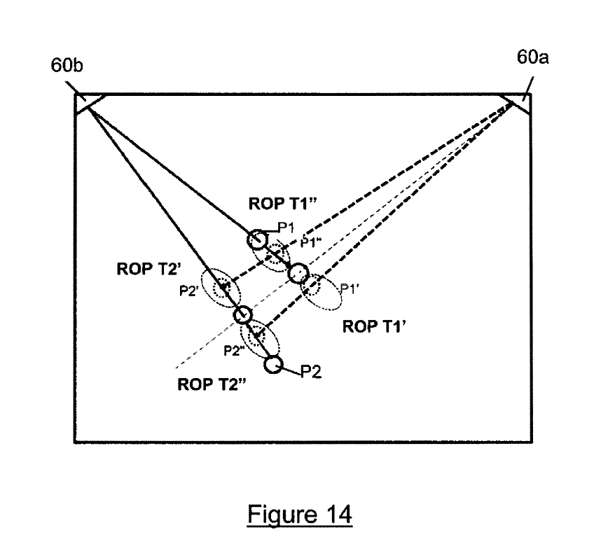

When the pointers again appear separate after the occlusion, a visual ambiguity arises. This ambiguity gives rise to two possible scenarios, which are schematically illustrated in FIGS. 13 to 15. Here, two pen tools T1 and T2 are generally approaching each along different paths, and from positions P1 and P2, respectively. During this movement, pen tool T2 becomes occluded by pen tool T1 in the view of imaging assembly 60a, while pen tools T1 and T2 appear separate in the view of imaging assembly 60b. FIG. 13 illustrates the case in which pen tools T1 and T2 continue in a forward direction along their respective paths after the occlusion. FIG. 14 illustrates the two possible positions for pen tools T1 and T2 after the occlusion. Because the pen tools continue moving forward along their respective paths in this scenario, the correct locations for T1 and T2 after the occlusion are P1′ and P2′, respectively. However, if only image data is relied upon, the DSP unit 26 cannot differentiate between the pen tools. Consequently, pen tool T1 may therefore appear to be at either position P1′ or at position P1″, and similarly pen tool T2 may appear to be at either position P2′ or at position P2″. However, by supplementing the image data with accelerometer data transmitted by the pen tools, this ambiguity can be resolved. As the ROP for each pen tool has been calculated using both accelerometer data and previous position data determined from image data, the DSP unit 26 is able to correctly identify the positions of pen tools T1 and T2 as being inside their respective ROPs. For the scenario illustrated in FIG. 13, the ROP calculated for pen tool T1 is T1′, and the ROP calculated for pen tool T2 is T2′.

Returning to FIGS. 9a and 9b, DSP unit 26 then calculates the two possible positions for each pen tool based on image data (step 718). Next, the DSP unit 26 evaluates the two possible positions for each pen tool (P1′ and P1″ for pen tool T1, and P2′ and P2″ for pen tool T2) and determines which of the two possible positions is located within the respective ROP for that pen tool. In the scenario illustrated in FIG. 13, the correct positions for T1 and T2 are P1′ and P2′, respectively, as illustrated in FIG. 14.

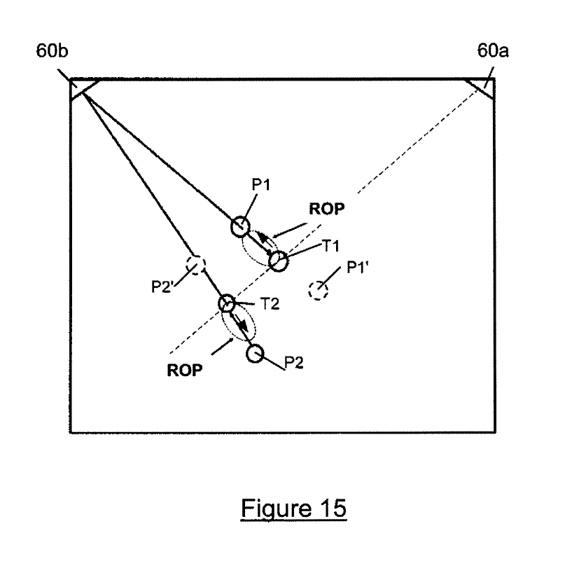

FIG. 15 illustrates the scenario for which pen tools T1 and T2 reverse direction during occlusion, and return along their respective paths after the occlusion. In this scenario, the ROP calculated for each of the pen tools differs from those calculated for the scenario illustrated in FIG. 13. Here, the ROP calculated for pen tools T1 and T2 are T1″ and T2″, respectively. DSP unit 26 then evaluates the positions P1′ and P1″ for pen tool T1 and determines which of these two possible positions is located inside the ROP calculated for T1. Likewise, DSP unit 26 evaluates positions P2′ and P2″ for pen tool T2 and determines which of these two possible positions is located inside the ROP calculated for T2. For the scenario illustrated in FIG. 15, the correct positions for pen tools T1 and T2 are P1″ and P2″, respectively, as shown in FIG. 14.

The approach used for finding the correct positions for two or more pointers is summarized from step 720 to step 738 in FIG. 9b. After occlusion (step 718), the DSP unit 26 determines whether the possible position P1′ lies within the calculated ROP T1′ (step 720). If it does, the DSP unit 26 then checks if the possible position P2′ lies within the calculated ROP T2′ (step 722). If it does, the DSP unit 26 assigns positions P1′ and P2′ to pointers 1 and 2, respectively (step 724). If pointer P2′ does not lie within the ROP T2′, then the DSP unit 26 will determine whether P2″ instead lies within ROP 2″ (step 726). If it does, the DSP unit 26 assigns positions P1′ and P2″ to pointers 1 and 2, respectively (step 728). If, at step 720, P1′ is not within the ROP T1′, DSP unit 26 determines whether position P1″ instead lies within ROP T1″ (step 730). If it does, the DSP unit 26 determines and assigns one of the two possible positions to pointer 2, (step 732 to step 738), in a similar manner as steps 722 through step 728. Accordingly, DSP unit 26 assigns position P1″ to pointer 1 and either position P2′ to pointer 2 (step 736) or position P2″ to pointer 2 (step 738). As will be understood by those of skill in the art, the pen tool tracking process is not limited to the sequence of steps described above, and in other embodiments, modifications can be made to the method by varying this sequence of steps.

As will be appreciated, even if a correction factor is unknown, the calculation of a ROP is still possible through a comparison of acceleration of the pen tool and previous motion of the pen tool. For example, if the pen tool is moving at a constant speed (no acceleration reported) and then suddenly accelerates, thereby reporting acceleration at some angle to its previous motion, the DSP unit 26 can search available image data and stored paths for any pointer that exhibits this type of motion.

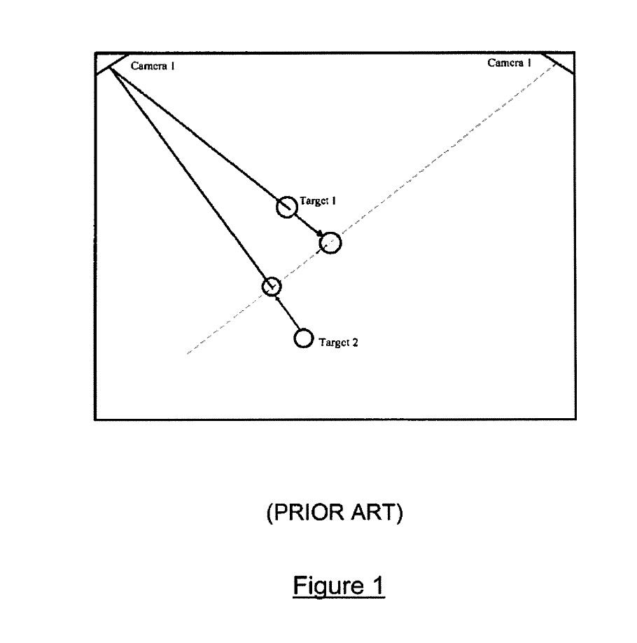

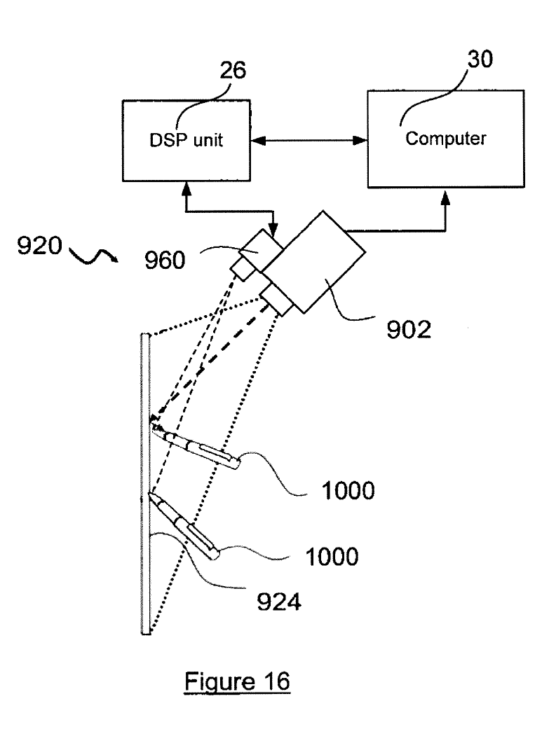

FIG. 16 shows another embodiment of an interactive input system, generally indicated using reference numeral 920. Interactive input system 920 is generally similar to interactive input system 20 described above with reference to FIGS. 1 to 15, except that it uses a projector 902 for displaying images on a touch surface 924. Interactive input system 920 also includes a DSP unit 26, which is configured for determining by triangulation the positions of pointers from on image data captured by imaging devices 960. Pen tools 1000 may be brought into proximity with touch surface 924. In this embodiment, the pen ID of each pen tool 1000 and the accelerometer data are communicated from each pen tool 1000 using infrared radiation. The pen tools provide input in the form of digital ink to the interactive input system 920. In turn, projector 902 receives command from the computer 32 and updates the image displayed on the touch surface 924.

As will be understood by those skilled in the art, the imaging assembly 960 and pen tool 1000 are not limited only to the embodiment described above with reference to FIG. 16, and may alternatively be used in other embodiments of the invention, and including a variation of the embodiment described above with reference to FIGS. 1 to 15.

As will be understood by those of skill in the art, still other approaches may be used to communicate the pen ID from the pen tool to the DSP unit 26. For example, each pen tool 200 could alternatively be assigned to a respective pen tool receptacle that would be configured to sense the presence of the pen tool 200 in the pen tool receptacle using sensors in communication with DSP unit 26. Accordingly, DSP unit 26 could sense the removal of the pen tool 200 from the receptacle, and associate the time of removal with the appearance of pointers as seen by the imaging assemblies.

Although in embodiments described above the interactive touch system is described as having either one or two imaging assemblies, in other embodiments, the touch system may alternatively have any number of imaging assemblies.

Although in embodiments described above the pen tool includes a two-axis accelerometer, in other embodiments, the pen tool may alternatively include an accelerometer configured for sensing acceleration within any number of axes.

Although in embodiments described above the pen tool includes a single accelerometer, in other embodiments, the pen tool may alternatively include more than one accelerometer.

Although in embodiments described above the DSP unit requests accelerometer data from the pen tool upon determining that more than one pointer is present, in other embodiments, the DSP may alternatively process accelerometer data transmitted by the pen tool without determining that more than one pointer is present. As will be appreciated, this approach requires less computational power as the DSP unit uses fewer steps in generally tracking the target, but results in greater consumption of the battery within the pen tool.

Although in embodiments described above the pen tool transmits accelerometer data upon when a tip switch is depressed, in other embodiments, accelerometer data may alternatively be transmitted continuously by the pen tool. In a related embodiment, the accelerometer data may be processed by the DSP unit by filtering the received accelerometer data at a predetermined data processing rate.

Although in embodiments described above the wireless unit, transmitter and receiver transmit and receive RF signals, such devices may be configured for communication of any form of wireless signal, including an optical signal such as an infrared (IR) signal.

Although preferred embodiments have been described, those of skill in the art will appreciate that variations and modifications may be made with departing from the spirit and scope thereof as defined by the appended claims.

What is claimed is:

1. An interactive input system comprising:
at least one imaging device having a field of view looking into a region of interest and capturing images;
at least one pen tool comprising an accelerometer configured to measure acceleration of the pen tool and to generate acceleration data, the pen tool configured to wirelessly transmit the acceleration data; and
processing structure configured to process the images and acceleration data to determine the location of at least one pointer in the region of interest.

2. The system of claim 1, wherein the at least one imaging device comprises at least two imaging devices.

3. The system of claim 2, wherein the processing structure is configured to process the images by triangulation.

4. The system of claim 1, wherein the at least one pointer comprises at least one pen tool.

5. The system of claim 4, wherein the at least one pointer further comprises at least one finger.

6. The system of claim 1, wherein the pen tool is configured for wirelessly transmitting the measured acceleration data using any of an optical signal and a radio frequency signal.

7. The system of claim 6, wherein the optical signal is an infrared signal.

8. The system of claim 1, wherein the at least one imaging device comprises one imaging device.

9. A pen tool for use with an interactive input system, the interactive input system comprising at least one imaging assembly capturing images of a region of interest, the interactive input system further comprising processing structure configured for locating a position of the pen tool when positioned in the region of interest, the pen tool comprising:
an accelerometer configured for measuring acceleration of the pen tool and generating acceleration data; and
a wireless unit configured for wirelessly transmitting the acceleration data.

10. The pen tool of claim 9, wherein the wireless unit is configured for wirelessly transmitting the acceleration data using any of an optical signal and a radio frequency signal.

11. The pen tool of claim 6, wherein the optical signal is an infrared signal.

12. A method of inputting information into an interactive input system comprising at least one imaging assembly capturing images of a region of interest, the method comprising:
determining the position of at least two pointers in the region of interest, at least one of the at least two pointers being a pen tool comprising an accelerometer and transmitting accelerometer data to the system, the determining comprising processing image data captured by the at least one imaging assembly and accelerometer data received by the system.

13. The method of claim 12, further comprising:
determining that occlusion of one of the pointers has occurred;
calculating a first acceleration for each pen tool based on the accelerometer data received by the system;
calculating a second acceleration for each pointer based on image data captured by the at least one imaging assembly; and
calculating a respective region of prediction for each pen tool based on the first and second accelerations; and
determining a correct position for each pen tool by assessing whether the pen tool lies within the respective region of prediction.

14. The method of claim 13, wherein the at least one pointer further comprises at least one finger, the method further comprising:
determining a correct position for each finger based on the correct position for determined for each pen tool.

15. The method of claim 13, wherein the processing image data comprises triangulation.

16. The method of claim 13, wherein the pen tool is configured for wirelessly transmitting the accelerometer data using any of an optical signal and a radio frequency signal.

17. The method of claim 16, wherein the optical signal is an infrared signal.

18. The pen tool of claim 9, wherein the wireless unit wirelessly transmits the acceleration data only once instructed to do so by the interactive input system.
